(19) United States
(12) Patent Application Publication
(10) Pub. No.: US 2008/0203231 A1
(43) Pub. Date: Aug. 28, 2008

(54) Control apparatus of wireless remote-control model and operating parameter setup system thereof

(76) Inventor: Shigetada Taya, Yokohama city (JP)

Correspondence Address: TROXELL LAW OFFICE PLLC, SUITE 1404, 5205 LEESBURG PIKE, FALLS CHURCH, VA, 22041, US

(21) Appl. No.: 12/071,750

(22) Filed: Feb. 26, 2008

(30) Foreign Application Priority Data
Feb. 26, 2007 (JP) 2007-045454

(51) Int. Cl. B64C 13/20

(52) U.S. Cl. 244/190

(57) ABSTRACT

A control apparatus of a wireless remote-control model and its operating parameter setup system is set up and changed by a personal computer, and various settings of setup information are transmitted to a wireless remote-control helicopter through a communication line, and control parameters are stored in a set value storage module of a memory, such that control parameters for the movement characteristics of a wireless remote-control model can be set up or changed easily to reduce the burden on the side of a signal transmitter.

### BACKGROUND OF THE INVENTION

1. Field of the Invention

The present invention relates to a control apparatus of a wireless remote-control model and operating parameter setup system thereof, and more particularly to a control apparatus that can easily set up or change a desired operating parameter of the model corresponding to an instruction signal transmitted from a signal transmitter for controlling standards such as posture or direction and also reduce the burden of the signal transmitter to simplify the structure of a wireless remote-control model.

2. Description of the Related Art

Wireless controlled models such as remote-control helicopters or vehicles are also known as wireless models or wireless remote controls, not only applied in the area of amateur hobbies, but also used extensively in many industries. A wireless remote-control model generally includes a signal receiver for receiving instruction signals from a signal transmitter, and a plurality of electronic control machines (or operating/controlling machines), a servomotor, a speed controller, a gyroscope, a battery for controlling the flying and driving of the wireless remote-control model. Further, it is necessary to appropriately set parameters (or desired operating parameters) in advance for controlling standards such as the angle of controlling a shudder or a power output characteristic, or freely change the settings of the aforementioned operating parameters to achieve different operating modes.

If a wireless remote-control model is used for flying or driving, it is necessary to appropriately set or change the shudder operating angle or the power output. For instance, an axial output of an electric motor is set to be nonlinear when the electric motor is used as a power source for a wireless remote-control helicopter, and a nonlinear change can achieve a very good operability and controllability. For an adjustment of a change to the gain or linearity of a shudder operating module, the aforementioned axial output of the electric motor can be set, while obtaining a good control of operations and providing the fun of the wireless remote-control model to users. The settings for the motive power and the control operations are divided into a mechanical portion such as the fixed angle of a servo swinging arm with respect to the driving axle of the servomotor and the connecting position of the servo swinging arm and a connecting wire, and an electric portion such as an electric output value set by a program. In recent years, the functions of the portion implemented by programs are extended such that detailed and diversified setup can be achieved.

A memory medium for storing memory control mode information is built in a wireless remote-control model, and the information stored in the memory medium is used for operating and controlling an object of the wireless remote-control model, and this prior art has been disclosed in a patent literature 1 (Japan Patent Laid Open Publication No. 2006-346144 of KOKAI Gazette). In a patent literature 2 (Japanese Published Unexamined Application No. 6-312065 Gazette), the patent literature 2 disclosed that the set value of a maximum allowed current of a power motor is stored in a memory in the driving of a wireless electric control car, and is an object changed according to an instruction from the signal transmitter.

If the setup information change method disclosed in the aforementioned patent literature 2 is used, more diversified parameter settings can be set or reset. FIG. 4 illustrates an embodiment of the setup and change of a previous control parameter of a signal receiver, wherein a wireless remote-control helicopter that uses an electric motor as a motive power is used as an example for illustrating the wireless remote-control model. Further, FIG. 5 is a schematic view illustrating electronic apparatuses such as a signal receiver or a driver control circuit installed in the wireless remote-control helicopter as depicted in FIG. 4. In FIG. 4, the wireless remote-control helicopter 100 is operated controlled by a signal transmitter 300. The wireless remote-control helicopter 100 carries a driver control circuit 101, and receives signals by a signal receiver 2 through a signal receiving antenna 102, and uses operating and controlling instruction signals decoded by a decoding module of the signal receiver 2 to drive and control a servomotor for a power motor, a collective pitch, a rudder, an elevating shudder and an aileron, etc.

A signal transmitter 300 comprises operating rods 301, 302, a display device 303 for displaying the setup characteristics, a signal transmitting antenna 304, a power switch, channel selectors 307, 308 and other switches 305, 306 etc. If the foregoing system is used for changing and setting information, any one of the switches 305, 306 is used for selecting an expected characteristic, and the display device 303 displays the set values for confirmation, and then any one of the switches 305, 306 is used for selecting a specific channel, and any one of the press switches 307, 308 is used for transmitting the information of set values to the wireless remote-control helicopter 100.

The wireless remote-control helicopter 100 receives the information of the set values by the signal receiver 2, and then a RF module 2A is used for amplifying and detecting waves and a decoder 2B is used for decoding to generate a drive signal of the motor driver and a drive signal of the existing servomotor. In other words, the signal receiver 2 as shown in FIG. 5 uses a high frequency signal processing module (RF module) 2A for the amplification and the wave detection of to a received signal wave, and a decoding module 2B for decoding. After the central control apparatus (CPU) 5 adjusts the operating and controlling instruction signals decoded by the decoding module 2B into a predetermined control signal type, the information is provided to a power motor 7 and a servomotor 8 for controlling the shudder through a driver 18, 19. In this embodiment, the drive signal of the power motor 7 is generated according to the set values stored in the memory 4 of the central control apparatus (CPU) 5. The foregoing signal corresponding to a maximum current of the power motor 7 in the operating control environment is generated, and the operating control instruction signal is used for adjusting the upper limit of a motor current modulation circuit of the driver 14 and the power motor 7 is set to a maximum current and driven by the maximum current.

The storage and change of the set value of the setup information (such as a control parameter) sent to the memory 4 is transmitted via a specific channel of the signal transmitter. As described in the patent literature 2, a change of the setup of any information of the aforementioned operating control instruction signal can be made by this method (which is a method of setting the set value by a signal receiver through an operating specific channel and storing the set value into the memory). To set or change a plurality of setup information of a control parameter by the aforementioned method, the signal transmitter 300 needs to carry the same number of functional components such as circuits and switches, etc.

As described above, the foregoing electric setup (including a change or a setup of a set value of an operating parameter) is carried out primarily by the setup and adjusting function of a signal transmitter for controlling the wireless remote-control model, and thus the number of functional components or circuit components installed in the signal transmitter will increase. In the meantime, more switches or knobs for implementing the setup function are required for transmitting the functional portion of the setup information, and many functions of the display device used for confirmation as well as the scale of the signal transmitter will be increased. However, there is a limitation on the size of the signal transmitter. Since there are diversified operations, the operability and functionality also have their limitation. In the method of setting or changing the set values disclosed in the patent literature 1, a maximum allowed current of the power motor can be changed by a signal transmitter that uses a specific channel. If the generated control signal fits the movement characteristics of the wireless remote-control model (including the type of the wireless remote-control model, and the movement characteristics according to each specific operating control instruction of the frame body, a detailed setup or change of the diversified set values will become very difficult.

### SUMMARY OF THE INVENTION

It is a primary objective of the present invention to provide a control apparatus of a wireless remote-control model and its operating parameter setup system, wherein a signal transmitter is used for setting or changing limited and diversified control parameter settings so that the wireless remote-control model can be set up or changed easily to reduce the burden of the side of the signal transmitter and enhance operating control performance.

To achieve the foregoing objective, the present invention provides a control apparatus comprising a driver control circuit installed on a frame body of a wireless remote-control model, and a memory for storing the areas of control parameter settings. The change of operating parameters (which is an operation on the setup information) can be implemented by connecting to an external device on the foregoing control apparatus through a communication line. Although the external device is preferably a personal computer (hereinafter referred to as “PC”), other equivalent information setup devices having the same function can be used as well. The PC must set the change the control parameter settings of the wireless remote-control model displayed on a display screen and change it to a desired value, which is the new generated control parameter (or the new set value). Such new set value is transmitted and stored directly to a set value storage area of a memory installed at a driver control circuit of the wireless remote-control model through a communication line. An external input terminal is disposed at a portion of a frame body of the wireless remote-control model and connected to the communication line. When the wireless remote-control model is not running, the communication line is connected to the PC to perform the aforementioned operation.

Further, the PC installs control operation simulation software of a wireless remote-control model. In the PC, the set value can be changed according to the foregoing setup and change of parameter information, and simulated, operated and controlled by using the control operation simulation software.

The above and other objectives and advantages of the present invention will become apparent with the detailed description accompanied with related drawings.

Preferred embodiments of this invention have been illustrated in the drawings, but it should be pointed out that any modification or variation of some elements of the invention or the arrangement of elements are conceivable within the scope of the patent claims of this invention.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a schematic view of a wireless control apparatus and its operating parameter setup system in accordance with the present invention;

FIG. 2 is a block diagram of a control parameter setup system in accordance with a preferred embodiment of the present invention;

FIG. 3 is a flow chart of setting a control parameter, and operating or generating an operating control instruction signal according to a set value, and a flying sequence in accordance with a preferred embodiment of the present invention;

FIG. 4 is a schematic view of using a signal receiver to set up and change the foregoing control parameter; and

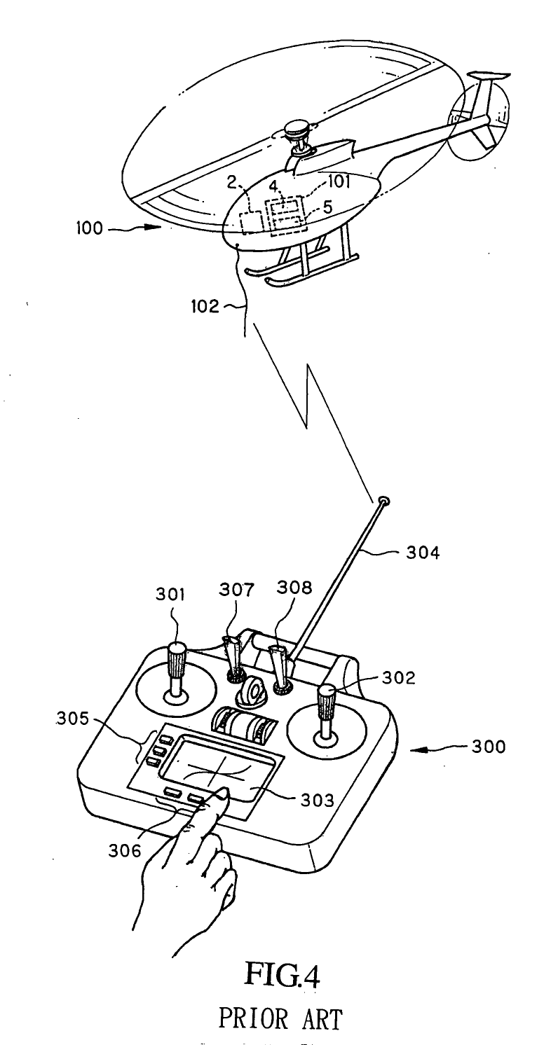

FIG. 5 is a block diagram of an electronic apparatus including a signal receiver or a driver control circuit installed in the wireless remote-control helicopter as depicted in FIG. 4.

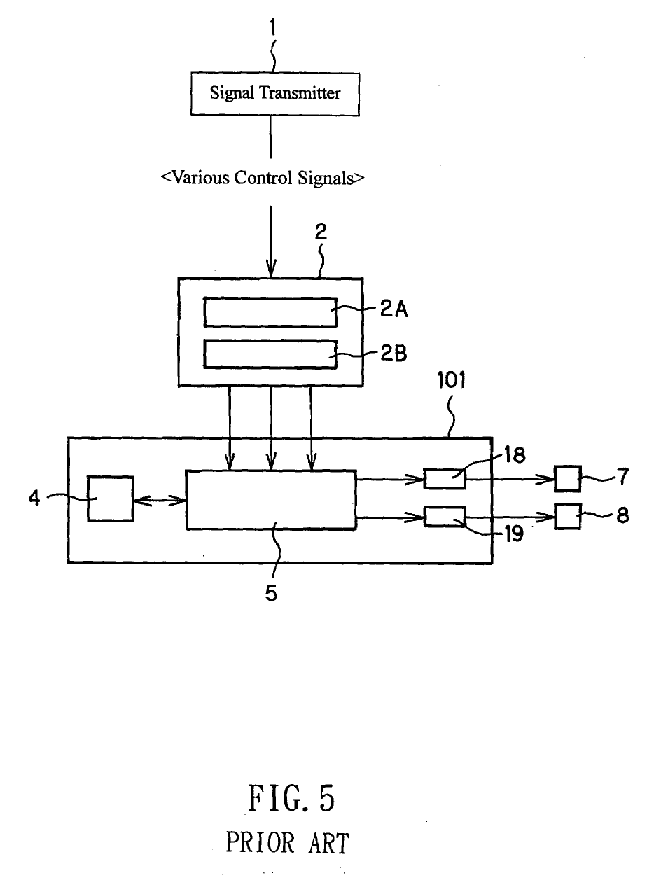

### DETAILED DESCRIPTION OF THE PREFERRED EMBODIMENTS

In the related figures of a preferred embodiment of the present invention, the same referring numerals are used for the same components for the illustration of the invention.

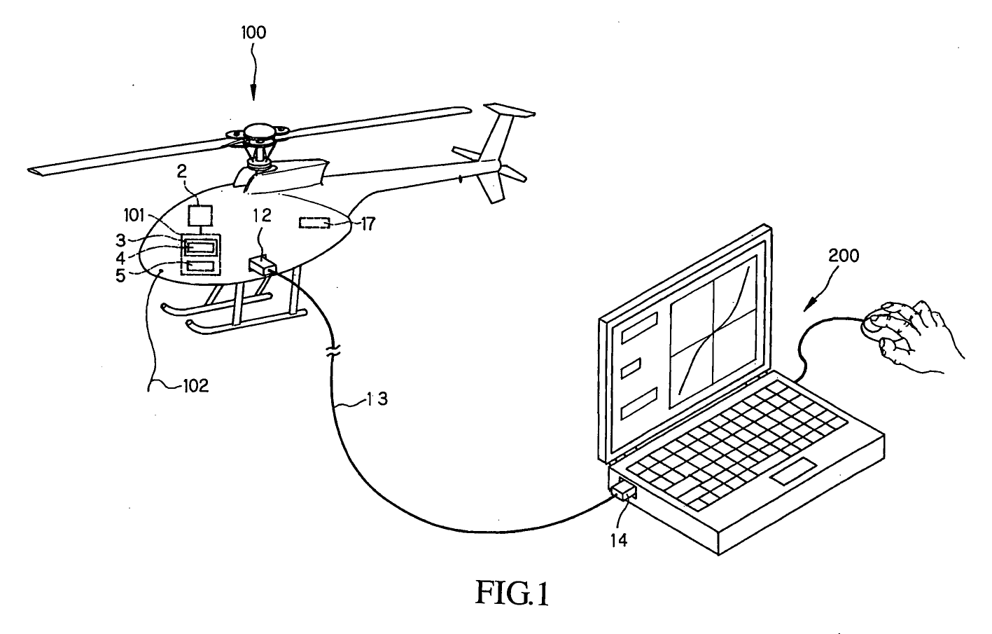

Refer to FIG. 1 for a schematic view of a wireless control apparatus and its operating parameter setup system in accordance with the present invention, a driver control circuit 101 of a wireless remote-control helicopter 100 installs a central control apparatus (CPU) 3, a set value storage module (memory) 4, a control signal assembly module 5 and other circuits. Further, the wireless remote-control helicopter 100 includes a connector 12 for connecting a PC connector 14 of an external device through a communication line 13. The signal receiver 2 comprises a high frequency (RF) processing module 2A, a wave detection module and a decoding module 2B, wherein the numeral 17 represents a battery.

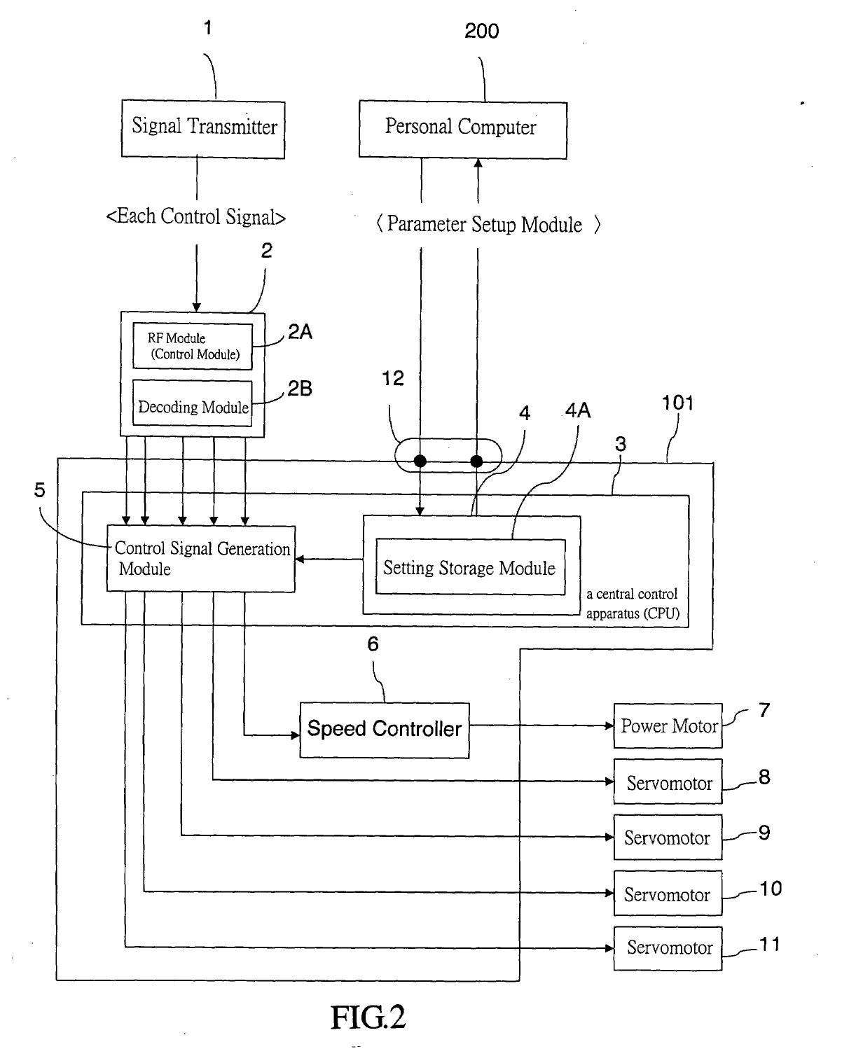

Referring to FIG. 2 for a block diagram of a control parameter setup system in accordance with a preferred embodiment of the present invention, the signal receiver 2 and the driver control circuit 101 as depicted in FIG. 1 are illustrated in detail. The numerals used in FIG. 2 are the same as those with the same function portions used in FIG. 1, wherein the numeral 6 refers to a speed controller, 7 for a power motor, and 8 to 11 refer to servomotors for steering a shudder. The servomotor for steering a shudder 8, 9, 10, 11 includes the servomotor for controlling a collective pitch, a rudder, an elevating shudder and an aileron.

In the assembly as shown in FIG. 1, the communication line 12 is connected directly to a PC 200 under the condition with the main power supply of the wireless remote-control helicopter 100 being on. In the PC 200, a built-in operating parameter operation program is used for generating desired control parameter settings. The control parameters including the driving characteristics of the power motor, and modified operation characteristics for a propeller, a steering wheel, an elevating shudder, and an aileron, etc. The control parameter settings are sent out from a medium of the PC200 through the communication line 12 and stored in the memory 4 of a set value storage module. The power supply can also supply power to the PC through the communication line.

During the periods of the power motor 7 of the wireless remote-control helicopter 100 from starting, rotating, flying to landing, a control signal modulated wave of an operating control instruction signal transmitted from the signal transmitter 1 is received by a signal receiver 2 installed in the wireless remote-control helicopter 100. The wave of the received signal is amplified and detected by a high-frequency processing module (RF module) 2A installed in the signal receiver 2, and decoded by the decoding module 2B to generate various operating control instruction signals. These operating control instruction signals are generated in the control signal assembly module 5 and stored as set values (or setup characteristics) in the memory 4. For example, an operating control instruction signal of a power motor 7 is stored as a set value in a set value storage module 4A for generating and specifying a gain or a linear input, as well as changing into a desired nonlinear output characteristic.

A flow chart is used for illustrating an example of an operating control instruction signal of a control signal assembly module 5. Before the setup information is transmitted to the wireless remote-control helicopter 100, the PC 200 uses a control parameter operation program to set up and change a desired control parameter, and keeps the result as the setup information in a file. Although it is not necessary to connect the PC 200 to the wireless remote-control helicopter 100 in advance, yet the efficiency of both PC 200 and wireless-control helicopter 100 will be better if they are connected.

Under the condition of having the PC 200 connected to the wireless remote-control helicopter 100, a main power source is supplied to the wireless remote-control helicopter 10 or a power source is supplied from the PC 200 through the communication line 13, so that the driver control circuit 101 will be at a ready state. Now, the operating parameter operation program of the PC200 is run, or the setup information stored in the aforementioned file is transmitted to the memory 4 of the wireless remote-control helicopter 100 after the operating parameter operation program is executed.

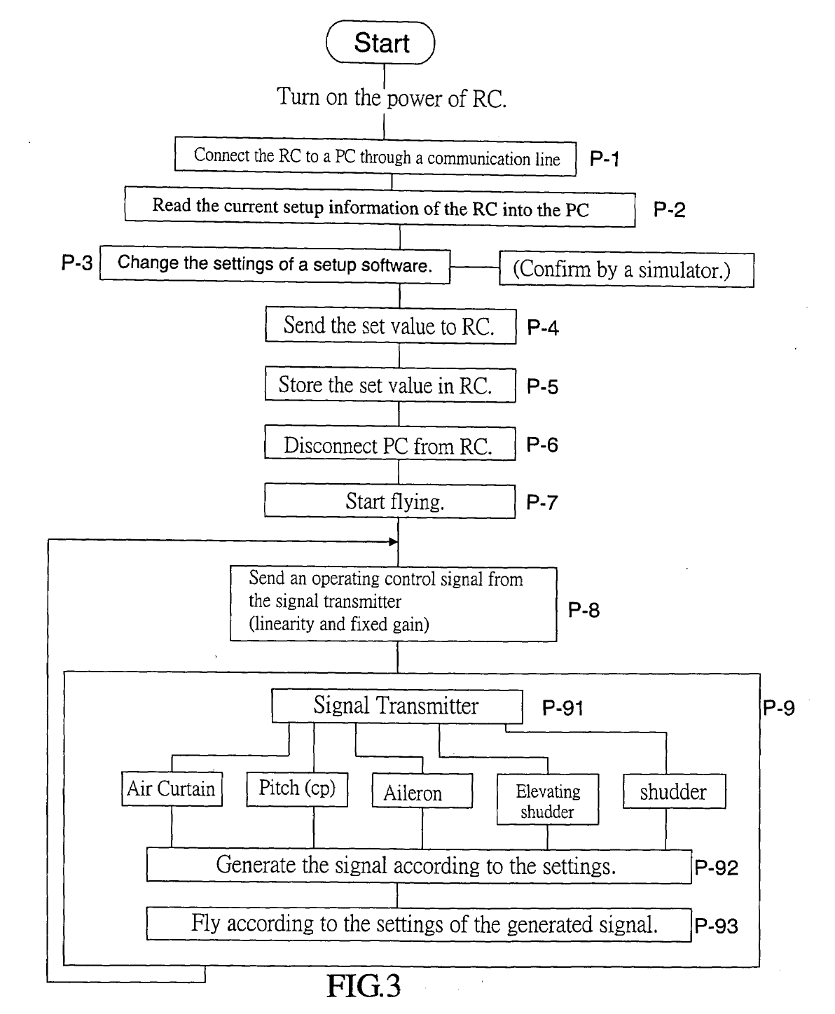

Referring to FIG. 3 for a flow chart of setting a control parameter, and operating or generating an operating control instruction signal according to a set value, and a flying sequence in accordance with a preferred embodiment of the present invention, P-1, P-2, and so on represents each processing procedure. In FIG. 3, the wireless remote-control (hereinafter referred to as “RC”) is powered on. In P-1, the communication line (hereinafter referred to as “Electric Wire”) is connected to the RC and the PC. In P-2, current setup information (or current setting) of the RC is read into the PC. In P-3, the set value set by the PC setup software is changed. It is preferably to use the simulation software to confirm the changed set value, but this procedure may be skipped.

In P-4, the set value is transmitted to the RC. In P-5, the set value is stored in a set value storage module 4A of the memory 4 of the R.C. In P-6, the electric wire is removed from the RC to set to a flying idle state. IN P-7, a start flying instruction signal is transmitted to the signal transmitter to start flying.

In P-8, the operating control signal is transmitted from the signal transmitter while the model is at a flying state. The operating control signal is linear and comes with a fixed gain. In P-9, the transmitted operating control signal is received by a signal receiver installed at the RC, and a driver control circuit is used for the processing according to the set value. In other words, the signal receiver performs high frequency amplification and wave detection for the received signal, and then decoded by a decoder as in P-91. In this embodiment, the operating control information transmitted from the signal transmitter is decoded to give the type of control signal including one of the air curtain (a rotary control of the power motor), pitch (a main pitch of a primary propeller), rudder, elevating shudder and aileron. The operating control signal is processed by one of the foregoing types into a plurality of operating control signals sequentially, but the processing ability of the control signal assembly module (microcomputer) is very powerful, and thus parallel processing can be achieved when a system with a multiple of channels is adopted for transmitting the instruction signals.

In P-92, the decoded control signals are generated according to the set values stored in the set value storage module 4A of the memory 4. In P-93, the RC control the operation of each control module according to the generated control signal. In the foregoing procedure of processing signals by the driver control circuit 101, the next operating control signal is waited for its receipt. If the received operating control signal is a new one, then the procedure of P-9 will be repeated.

Each of the foregoing generated operating control instruction signals is provided to a driving control mechanism that follows, for controlling each controlled target. In other words, in the embodiment as shown in FIG. 2, a power motor control signal and four steering signals are outputted from the control signal assembly module 5. The four steering signals include a collective pitch control signal, a rudder control signal, an elevating shudder control signal and an aileron control signal. Further, the power motor control signal is applied to a power motor 7 through a speed controller 6, and the four steering signals (control signals) are applied to the servomotor 8, 9, 10, 11 for controlling each control portion. The power motor control signal and the steering signal may be control signals required by control portions of various types of wireless remote-control models according to the type of the wireless remote-control model.

The setup of the previously mentioned electric control parameter is achieved by the setup function built in the signal transmitter. With the limitations of size and cost of the signal transmitter, the number of setup input switches or the limitations of the function of transmitting setup information or the size of the display device, it will not be easy to input the setup or achieve a detailed setup because the enhancement on operability or functionality is limited. In this preferred embodiment, the wireless remote-control model installs an electric storage module for the control parameter settings, and the set values can be changed or operated by referring to the PC screen at the same time, and the result is transmitted to the wireless remote-control model through the communication line. Any new setup information from the operation of the PC will be stored into the wireless remote-control model through the communication line for later use.

In this embodiment, the PC installs a flight control computer simulation software of the wireless remote-control helicopter, such that the setup information is linked with the control parameter settings for reflecting the signal transmitter or the PC keyboard on a PC screen for a computer simulation of flying the wireless remote-control helicopter. The wireless remote-control model of the invention is not limited to a helicopter model only, but also applies to other models.

In summation of the description above, the values of the operating control instruction signal instructions transmitted from the signal transmitter is linear, which can be a pulse width or a linear characteristic signal that is not generated. Basically, a default setting of the signal transmitter can be used. The values of the instructions of the linear operating control instruction signals transmitted from the signal transmitter are the set value stored in the set value storage module of the memory installed on the frame body of the wireless remote-control helicopter and used as a drive signal, for changing the pulse width or generation curve characteristic, so as to control the control modules.

In the foregoing embodiment, a helicopter is used for illustration, but the present invention is not limited to helicopters only, and the invention can also be applied to a fixed-wing wireless remote-control plane, a wireless remote-control car, a wireless remote-control boat and other wireless remote-control models.

Thus, the change and setup of a set value of a desired control parameter and the storage of set parameter in a memory no longer need a signal transmitter to reduce the burden of the signal transmitter, simply its structure, and achieve the effects of miniaturizing and lightening the model easily. The change and setup operations of the set values allows detailed and easy-to-understand information (such as the order of setting or changing the control parameters) to be displayed on a display screen easily by means of a setup software installed in the PC, and such arrangement makes the setup operation much easier.

The flying or driving control operation simulation software of the wireless remote-control model installed in the PC links the simulated settings on the PC with the operated, controlled and simulated control parameters (or settings) to achieve the flying or driving computer simulation of the set value of the wireless remote-control model reflected from the signal transmitter or the keyboard onto the PC screen, so as to confirm and change the settings before setting the wireless remote-control model.

With the change (or the change of component characteristic information) of instructing the wireless remote-control model component (or functional component), the control operation simulation software can be used for automatically matching the set values with the corresponding component characteristics and conducting a flying or driving computer simulation, and forming the operating control status of a new component.

In view of the detailed description above, the present invention can be achieved by those ordinarily skilled in the art and is in compliance with the requirements of patent application, and thus is duly filed for patent application.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control apparatus of a wireless remote-control model, having a driver control circuit, and said driver control circuit comprising:
a signal receiving circuit;
a decoder, for decoding a signal received by said signal receiving circuit from a signal transmitter into an operating control instruction signal; and
a servomotor, for controlling a speed or a posture position according to said operating control instruction signal decoded by said decoder;
wherein said driver control circuit includes a central control apparatus, and said central control apparatus comprises:
a memory, having a set value storage module, for storing an operating control characteristic of said wireless remote-control model to set up a control parameter setting; and
a control signal assembly module, for generating an operating control instruction signal decoded by said decoder according to said setting stored in said set value storage module;
characterized in that said operating control signal generated by a control signal assembly module is outputted to a controller or said servomotor for controlling a speed or a posture position.

2. The control apparatus of a wireless remote-control model as recited in claim 1, wherein said wireless control frame body includes an external input terminal connected directly to an external device through a communication line, for providing said control parameter to said set value storage module of said memory before said external device is used for operating said wireless remote-control frame body.

3. An operating parameter setup system of a wireless remote-control model, having a driver control circuit, and said driver control circuit comprising:
a signal receiving circuit;
a decoder, for decoding a signal received by said signal receiving circuit from a signal transmitter into an operating control instruction signal; and
a servomotor, for controlling a speed or a posture position according to said operating control instruction signal decoded by said decoder;
wherein said wireless remote-control model comprises:
a memory, having a set value storage module, for storing a desired control parameter setting that sets up an operating control characteristic;
an external input terminal, for transmitting information directly and externally from said memory; and
an external device, connected directly to said external input terminal through a communication line for maintaining said control parameter setting of said wireless remote-control model;
characterized in that said control parameter is transmitted from said external device to said memory, and stored in said memory.

4. The operating parameter setup system of a wireless remote-control model as recited in claim 3, wherein said external device is a personal computer, characterized in that said personal computer generates a desired control parameter setting of said wireless remote-control model, and transmits and stores said control parameter setting into said set value storage module of said memory through said communication line.

5. The operating parameter setup system of a wireless remote-control model as recited in claim 4, wherein said personal computer installs a control operation simulation software of said wireless remote-control model, characterized in that a new control parameter setting is generated or changed according to said control parameter setting of said personal computer for simulating, operating or controlling said wireless remote-control model by the personal computer.
